(19) United States
(12) Patent Application Publication
(10) Pub. No.: US 2020/0277875 A1
(43) Pub. Date: Sep. 3, 2020

(54) Apparatus and Methods for Direct Sensing of Rotational Dynamics of a Rotating Shaft

(71) Applicant: Electric Power Research Institute, Inc., Palo Alto, CA (US)

(72) Inventors: Stephen Hesler, Mooresville, NC (US); Christopher Suprock, Exeter, NH (US)

(21) Appl. No.: 16/796,068

(22) Filed: Feb. 20, 2020

Related U.S. Application Data
(63) Continuation of application No. 15/360,922, filed on Nov. 23, 2016, now abandoned.
(60) Provisional application No. 62/259,609, filed on Nov. 24, 2015.

(51) Int. Cl. F01D 21/00; H04Q 9/00

(52) U.S. Cl. CPC F01D 21/003; H04Q 9/00; Y02T 50/671; F05D 2240/60; H04Q 2209/40; F05D 2220/31

(57) ABSTRACT

The invention and its various embodiments are directed to a telemetry system for measuring rotordynamic data from a rotating shaft of interest and methods for using the same. The invention provides a single housing that can include multiple, different sensors that measure various rotordynamic parameters, such as both strain and acceleration, in parallel. A power and data antenna is electrically attached to the housing and the sensors for receiving radio frequency power to power the sensors and to wirelessly transmit data collected by the sensors. Both the housing and the power and data antenna are attached to a rotating shaft and are encapsulated in a fiber coating.

### CROSS-REFERENCE TO RELATED APPLICATIONS

This application is a continuation of prior application Ser. No. 15/360,922, filed Nov. 23, 2016, which claims the benefit of provisional Application No. 62/259,609, filed Nov. 24, 2015. The entireties of the foregoing applications are incorporated by reference herein.

### BACKGROUND OF THE INVENTION

### Field of the Invention

The invention and its various embodiments are directed to an apparatus, system, and method for measuring natural frequencies of rotating shafts. In particular, the invention and its various embodiments are directed to a telemetry system that includes a single, compact telemetry module attached to a rotating shaft, such as a steam turbine generator shaft, to monitor various rotordynamic data using multiple, different sensors within the module; a radio frequency power transmitting antenna connected to a radio frequency power supply to wirelessly provide power to the telemetry module; and a data receiving antenna for wirelessly receiving the rotordynamic data from the telemetry module.

### Description of Related Art

The shaft systems on large grid-connected steam turbine generators can be subjected to dynamic torque oscillations caused by negative sequence currents in the generator. These currents can be grid-induced or caused by unbalanced electrical shorts in the windings.

The resulting torsional stimulus is applied to the generator rotor at twice the line frequency and can result in vibratory response of the entire turbine generator shaft train. Although the torsional stimulus amplitude is very low compared to the static torque produced by the turbine, the resulting torsional response of the shaft system can be amplified if this stimulus frequency is aligned too closely with a natural frequency of the lightly damped shaft system. If undetected, the resulting torsional vibration can lead to accumulation of high-cycle fatigue damage in highly stressed rotor elements, such as turbine blades, couplings, exciter shafts, and retaining rings.

The design strategy for reducing the risk of torsional-induced component failures is to ensure that torsional natural frequencies of the shaft systems are sufficiently detuned from the induced stimulus occurring at specific harmonics of the shaft speed. Proper detuning can be verified by measuring the torsional natural frequencies from the operating steam turbine generator.

Relatedly, the effect of upgrades to existing turbine-generator sets on torsional vibration must also be considered. These upgrades commonly include the replacement of entire elements such as low-pressure turbine rotors, generator rotors, or exciters. The new elements introduce changes to the distribution of torsional stiffness and inertia, which result in small changes to the natural frequencies and mode shapes of the entire shaft system. These frequency changes could move the shaft closer to a resonant condition with the generator rotor excitation stimulus at twice line frequency. While the effect of changes in natural frequencies for an upgrade could be evaluated using rotordynamic models, uncertainty in the model prediction requires the imposition of a wide frequency “avoidance” band surrounding the twice-line-frequency excitation.

ISO Standard number 22266-1:2009 provides shaft torsional vibration frequency avoidance criteria. These criteria form the basis for loss control standards by plant insurers such as the Nuclear Electric Insurance Limited (NEIL). The standards provide an incentive for plant operators to measure unit-specific torsional frequencies rather than rely only on model predictions. Unit-specific measurements eliminate the model uncertainty, permitting turbine generator operation in a narrower frequency avoidance window.

Current systems for identifying the torsional natural frequencies typically require the use of custom-fit shaft collars or temporary belts, induced power systems, and a stationary ring-antenna surrounding an exposed portion of the shaft. The custom-fit collars require a unit outage to accurately measure the shaft diameter, followed by a collar procurement lead-time. Furthermore, these systems, once installed, are often used for torsional testing over limited time durations, typically a few days—not long-term monitoring applications. Accordingly, the practical difficulties in cost-effective deployment of this technology in a commercial power plant environment has limited its widespread use.

As a result, the power generation industry needs a cost-effective and reliable technology for measurement of shaft natural frequencies on operating units. The technology should providing monitoring of different attributes of rotordynamic behavior that are needed to fully define shaft vibration and should be provided in a compact design. In addition, the technology should be capable of being installed and used with minimal impact on plant operations and sufficiently rugged to survive long-term monitoring duty.

### BRIEF SUMMARY OF THE INVENTION

In general, the present invention and its various embodiments are directed to a telemetry system for monitoring, measuring, or collecting rotordynamic data from a rotating shaft of interest. In some embodiments, the present invention is designed for application on high-speed shafts used in power generation, such as a steam turbine generator shaft; propulsion; and process plants; or for any application for which monitoring of several aspects of shaft rotordynamics in parallel is desired.

The present invention accomplishes measurement of rotordynamic characteristics (torsional and lateral vibration) of operating turbomachinery shafts by placing sensors directly on the rotating shaft surface and using radio telemetry to transmit data to a stationary receiver. The present invention provides a single housing that can include multiple, different sensors that measure various rotordynamic parameters, such as both strain and acceleration, in parallel or concurrently to provide different attributes of the shaft rotordynamic behavior. A power and data antenna is electrically attached to the housing and the sensors for receiving radio frequency power to power the sensors and to wirelessly transmit data collected by the sensors. Both the housing and the power and data antenna are attached to a rotating shaft and are encapsulated in a fiber coating or band. A radio frequency power supply and a radio frequency antenna, electrically connected to the radio frequency power supply, transmits the radio frequency waves to the power and data antenna. The radio frequency power supply and a radio frequency antenna are not attached to the rotating shaft but are located proximately to where the housing and power and data antenna are positioned on the shaft. A device that receives data, such as a data receiving antenna, is also located proximately to where the housing and power and data antenna are positioned on the shaft and receives data collected by the sensors from the power and data antenna, which can be passed to a computer for subsequent processing and analysis.

In one embodiment, the present invention provides a system for monitoring rotordynamic parameters of a rotating shaft, comprising a telemetry module, configured for attachment to the surface of a rotatable shaft, comprising a transceiver and at least two sensors for sensing different rotordynamic parameters; a power and data antenna, configured for attachment to the surface of the rotatable shaft and for electrical connection to said telemetry module, for receiving radio frequency waves to supply power to said telemetry module and for sending data collected by said at least two sensors from said telemetry module to a data receiving device; a radio frequency power supply; and a radio frequency antenna, electrically connected to said radio frequency power supply, for emitting radio frequency waves.

In another embodiment, the present invention provides a method for monitoring rotordynamic parameters in a rotating shaft, comprising sensing more than one rotordynamic parameter of a rotating shaft using a single sensor for each of the more than one rotordynamic parameters to collect rotordynamic data, wherein each of the sensors is located within a single housing attached to the rotating shaft; and passing the rotordynamic data wirelessly to a remote computer.

### BRIEF DESCRIPTION OF THE SEVERAL VIEWS OF THE DRAWINGS

FIG. 1 illustrates a system for monitoring a rotating shaft according to one embodiment of the present invention;

FIG. 2 is a photograph of a prototype installation of a telemetry module on a shaft prior to encapsulation according to one embodiment of the present invention;

FIG. 3 is a photograph of an epoxy infusion process to encapsulate a prototype telemetry module according to one embodiment of the present invention;

FIG. 4 is a photograph of a prototype installation of a telemetry module on a shaft according to one embodiment of the present invention;

FIG. 5 is a photograph of a prototype installation of a telemetry module on a shaft showing a close-up of the completed epoxy infusion according to one embodiment of the present invention;

FIG. 6 is an exemplary graph of shaft strain versus time data for a generator trip illustrating a technique for analyzing data provided by a system for monitoring a rotating shaft according to one embodiment of the present invention;

FIG. 7 is an exemplary spectral plot of shaft strain for a generator at various load points illustrating a technique for analyzing data provided by a system for monitoring a rotating shaft according to one embodiment of the present invention; and

FIG. 8 is an exemplary graph of shaft strain versus time data for a generator trip illustrating one technique for analyzing data provided by a system for monitoring a rotating shaft according to one embodiment of the present invention.

### DETAILED DESCRIPTION OF THE INVENTION

The present invention is more fully described below with reference to the accompanying figures. While the invention will be described in conjunction with particular embodiments, it should be understood that the invention can be applied to a wide variety of applications, and it is intended to cover alternatives, modifications, and equivalents within the spirit and scope of the invention. Accordingly, the following description is exemplary in that several embodiments are described (e.g., by use of the terms “preferably,” “for example,” or “in one embodiment”), but this description should not be viewed as limiting or as setting forth the only embodiments of the invention, as the invention encompasses other embodiments not specifically recited in this description. Further, the use of the terms “invention,” “present invention,” “embodiment,” and similar terms throughout this description are used broadly and are not intended to mean that the invention requires, or is limited to, any particular aspect being described or that such description is the only manner in which the invention may be made or used.

In general, the present invention and its various embodiments are directed to a telemetry system for monitoring, measuring, or collecting rotordynamic data from a rotating shaft of interest. The present invention is designed for application on high-speed shafts used in power generation, such as a steam turbine generator shaft; propulsion; and process plants; or for any application for which monitoring of several aspects of shaft rotordynamics in parallel is desired.

The present invention accomplishes measurement of rotordynamic characteristics (torsional and lateral vibration) of operating turbomachinery shafts by placing sensors directly on the rotating shaft surface and using radio telemetry to transmit data to a stationary receiver. Maximum measurement sensitivity is desirable for effective condition trending and is achieved by that direct placement of the sensors. Accordingly, the present invention provides a single housing that can include multiple, different sensors that measure various rotordynamic parameters, such as both strain and acceleration, in parallel or concurrently to provide different attributes of the shaft rotordynamic behavior.

It should be appreciated that it is important to provide a system that allows for measurement of more than one parameter. Because the choice of sensor locations along the shaft length is often limited to a few areas for which the shaft is exposed or in an otherwise suitable environment, measuring only one parameter, such as strain, may result in missing a mode of shaft vibration if that mode shape does not exhibit sufficiently strong shaft bending or torque at the sensor location. Likewise, a single accelerometer may miss a mode that mainly exhibits strain rather than motion at the chosen sensor location. By integrating both strain and acceleration into a single sensor system, it will be possible to observe measureable vibration parameters for all modes, regardless of the mode shapes, at a single compact sensor position.

In addition, because available space on the shaft for sensor placement is limited in many cases, the single housing of the present invention provides a more compact device for attachment to the shaft to minimize required surface are on the shaft and to allow for attachment to available surface area of the shaft. Further, the present invention provides for encapsulation of the housing on the shaft to attach the housing and the sensors to the rotating shaft, which allows for relatively easier attachment compared to separately attaching multiple sensors, provides a customized cover for the housing and the sensors, provides for protection of the attached housing and sensors during use, and allows for indefinite use of the sensors or continued use without any predetermined date for removal of the sensors thereby providing collection of long-term data and avoiding system shutdowns to remove multiple sensors temporarily attached at various locations along the shaft compared to typical measurement systems that are only installed temporarily.

In one general embodiment, the present invention includes a single, compact telemetry module having a single housing within which resides a transceiver, one or more sensors, and related circuitry. The telemetry module is attached to the surface of a rotating or rotatable shaft of interest. The sensors collect data about the shaft, including rotordynamic data, such as elastic (bending/twisting) and inertial (acceleration) data that may also be measured in twist (torsion) and radial (lateral displacement) directions. It should be appreciated that these parameters may be measured in parallel by the present invention. Together, these parameters define key rotordynamic vibration characteristics of the shaft to allow for monitoring of the shaft's natural frequencies and torque fluxuations.

The system also includes a power and data antenna that is electrically attached to the telemetry module and is also attached to the rotating shaft. The power and data antenna provides power received from a separate power source to the telemetry module and sends data collected by the sensors in the telemetry module to a device that receives data for subsequent processing by a computer. Accordingly, in some embodiments, the power and data antenna is a dual band antenna that allows for both the receipt of power at one frequency and the passing of data at a second frequency. Accordingly, the circuitry in the telemetry module may be diplexing. The power and data antenna is also enclosed by the encapsulation used for the housing, thereby providing similar advantages for the antenna.

The telemetry module and the power and data antenna are attached to a rotating shaft, such as a steam turbine generator shaft, to measure and collect various rotordynamic data. The telemetry module and the power and data antenna are encapsulated in a band of material that accordingly adheres both the telemetry module and the sensors to the surface of the shaft. A radio frequency power transmitting antenna connected to a radio frequency power supply emits radio frequency waves that are picked up by the power and data antenna to essentially wirelessly provide power to the telemetry module via its diplexing circuitry. The collected data is wirelessly passed by the power and data antenna to a receiving device, which may be a data receiving antenna that is connected to a computer that can be used to process and analyze the collected data. For example, in one embodiment, the sensors may measure dynamic strain and acceleration on the shaft and that collected data is used to determine the torsional natural frequency of the shaft to allow for detuning of those frequencies from induced stimulus occurring at specific harmonics of the shaft speed. Following, various embodiments of the above general invention are described in more detail in connection with the Figures.

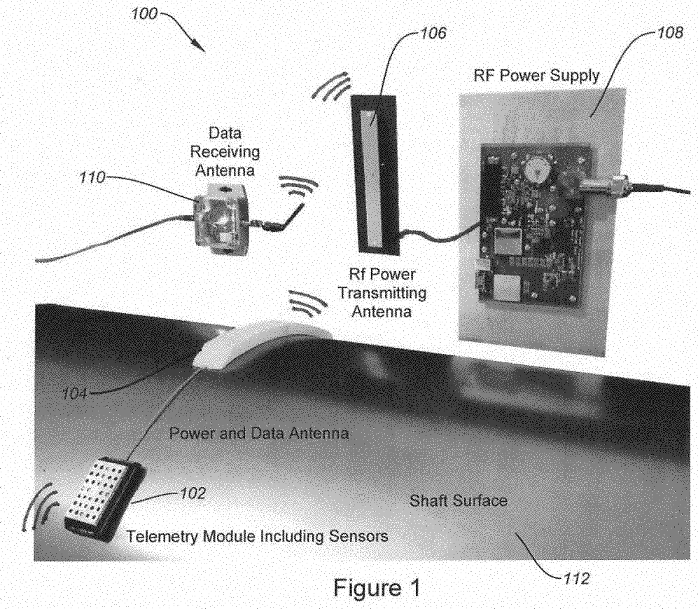

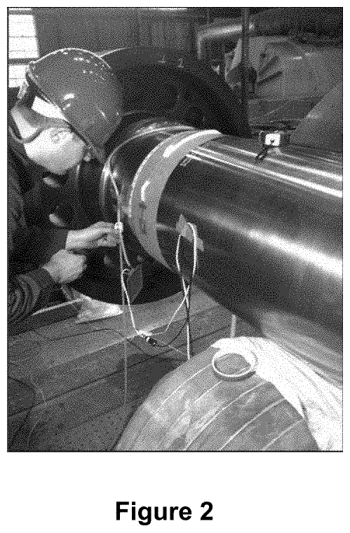

FIG. 1 illustrates a system for monitoring a rotating shaft according to one embodiment of the present invention. The system 100 includes a telemetry module 102, a power and data antenna 104, a radio frequency (RF) power transmitting antenna 106, an RF power supply 108, and a data receiving antenna 110. The telemetry module 102 and the power and data antenna 104 are attached to a shaft 112 that is the rotating shaft for which the measurement of rotordynamic data is desired. The radio frequency (RF) power transmitting antenna 106, RF power supply 108, and data receiving antenna 110 are located proximate to or near the shaft 112 or the location where the power and data antenna 104 is positioned but are not attached to the shaft 112 and are stationary. In some embodiments, the system 100 is designed for application on high-speed shafts used in power generation, propulsion, process plants, or any application for which monitoring of several aspects of shaft rotordynamics in parallel is a requirement. FIG. 2 is a photograph of a prototype installation of a telemetry module on a shaft prior to encapsulation (discussed further below) according to one embodiment of the present invention.

The telemetry module 102 is a highly integrated compact sensor system that includes a single housing within which resides one or more sensors, a transceiver, and related diplexing circuitry. The telemetry module 102 provides a compact package with much lower mass and power consumption than conventional telemetry systems, and the need for a custom-fitted shaft collar or temporary belt is eliminated. It should be appreciated that the size of the telemetry module 102 is such that it may be applied on various shaft diameters without costly customization.

The sensors are used to measure various rotordynamic parameters about the shaft as it rotates. In one embodiment, the sensors measure shaft surface strain as a basis for assessing torsional vibration amplitude and frequencies. In another embodiment, the sensor design adds shaft surface acceleration measurements. In general, the design would improve sensitivity to resolve low levels of torsional vibration associated with modes having low elastic energy at measurement locations. The sensor would have a low “noise floor,” which would allow capture of low-amplitude mode frequency indications that can be hidden by traditional wireless instrumentation. A high measurement sampling rate would ensure sufficient frequency resolution to verify that natural frequencies are fully outside the avoidance band at normal running conditions. In addition, the design does not require custom-fitted components and takes advantage of available low-cost microelectronics.

In some embodiments, the telemetry module 102 includes two strain gages and two accelerometers in a low-mass package that can be attached to the shaft surface 112 using an epoxy encapsulation system (discussed further below). The gage and accelerometer configurations allow both elastic (bending/twisting) and inertial (acceleration) to be sensed in parallel or simultaneously. The two directions sensed are twist (torsion) and radial (lateral displacement). In other words, the gages and accelerometers are configured to simultaneously measure shaft torsional vibration and lateral vibration, which improves mode frequency detection regardless of the mode shape at the selected transceiver location on the shaft. For example, in applications such as shaft torsional mode identification, the use of such sensors will reduce the risk that modes of interest will be inactive (not sensed) because they exhibit either purely elastic, or purely inertial energy at the selected sensor location. Accordingly, together, these four parameters fully define key rotordynamic vibration characteristics of the shaft 112.

In some embodiments, the sensors include strain gage-based accelerometers to lower power consumption compared to piezoelectric accelerometer options. In addition, the directionality is improved and transverse (off-axis) sensitivity is lower with this accelerometer technology.

The transceiver is capable of sending and receiving data. Accordingly, the transceiver can receive control data for the telemetry module 102 and the sensors and can transmit the data collected by the sensors. In one embodiment, a wireless, battery-free, transceiver digitally transmits strain and acceleration data obtained from the shaft surface by the sensors. In one embodiment, the transceiver board transmits a 2.4 GHz signal that contains the strain and acceleration digital data stream. This is received and demodulated by the stationary data receiving antenna 110. The resulting data can then be passed to and archived on a computer. It should be appreciated that the circuitry used in the telemetry module 102 may be diplexing circuitry that allows for radio frequency data and power excitation to eliminate a separate radio antenna, reduce size, and allow for increased data radio performance by using a larger antenna.

It should be appreciated that installation of the telemetry module 102 on the shaft surface 112 basically permits four separate sensors to be attached to the shaft surface 112 in a fraction of the time that would otherwise be required to install four sensors separately. In some embodiments, the installation of the system 100 can be performed within one working shift or within eight hours or less than eight hours, which is valuable, particularly when equipment maintenance downtime is time-constrained.

It should also be appreciated that the telemetry module 102 can be easily grounded to the shaft 112, including any diameter shaft, without welding or any permanent attachment. For example, gold spring pins on the telemetry module 102 may be used to enable confident electrical grounds without the need to physically solder or weld to the shaft metal. This improves electrical performance and noise immunity.

Moreover, it should be appreciated that the various components within the telemetry module 102, and in particular the sensors, are attached to a circuit board that is flexible in design. Such a flexible board allows the strain gage bonding to the shaft surface to be accomplished in parallel with the overall telemetry epoxy infusion process discussed further below. Further, the use of a flexible board allows the telemetry module 102 to be installed on shafts having various diameters as the flexible board is able to conform to a given diameter shaft. In some embodiments, the surface measurement strain gages are located on a flexible strip or board backed by silicone foam. This foam applies the correct pressure to conform the gage strip and set the gage adhesive without requiring elaborate vacuum bonding pads or equipment. Traditional strain gage layup is also eliminated and, again, installation time is reduced.

In addition, where shaft surface area 112 is limited, the compact and pre-assembled design of the telemetry module 102 allows the four sensors to be easily installed on one side of the shaft 112. This leaves sufficient room for a completely redundant system to be installed on the opposite side of shaft 112. Redundant sensors decrease the risk that a damaged sensor will compromise the use of the system 100.

In addition, a “light bar” may be used in connection with the telemetry module 102. The light bar displays synchronous to shaft RPM and display information (text) on the shaft surface with persistence of vision.

Further, a fast response light sensor on the telemetry module 102 may be used to detect a stationary key phasor (laser). This is a unique way to address group delay differences in the digital system 100 leading up to data acquisition. Putting the tachometer on the telemetry module 102 allows the phase to remain accurate through any number of digital repeaters (hubs) or in buffer delays that may occur in the installation. It also enables the use of USB and Ethernet as viable time aligned data transfer methods.

The power and data antenna 104 is electrically connected to the telemetry module 102 as shown in FIG. 1. The power and data antenna 104 provides power received from a separate power source to the telemetry module 102 and sends data collected by the sensors in the telemetry module 102 to a device 110 that receives data and that may pass that data to a computer, for example, for subsequent processing and analysis. Accordingly, in some embodiments, the power and data antenna 104 is a dual band antenna that allows for both the receipt of power at one frequency and the passing of data at a second frequency. Correspondingly, as noted above, the circuitry in the telemetry module 102 may be diplexing to allow for the interface with the dual band power and data antenna 104.

It should be appreciated that in some embodiments, multiple power receiving antennas may be used. In this case, the telemetry module 102 will have multiple corresponding ports for each antenna input. Multiple power receiving antenna connections enable additive power collection from various excitation frequencies and/or physical locations to excite and power the telemetry circuit. Accordingly, the multiple antenna inputs may be used simultaneously.

The telemetry module 102 and the power and data antenna 104 are both attached to the surface of the shaft 112. In one embodiment, the telemetry module 102 and power and data antenna 104 are encapsulated by using an adhesive, such as epoxy to completely surround the telemetry module 102 and power and data antenna 104, thereby sealing each to the surface of the shaft 112. Accordingly, the outside of the telemetry module 102 and power and data antenna 104 would be covered. In one embodiment, the adhesive is an infused epoxy impregnated fabric that covers the telemetry module 102 and power and data antenna 104 and thereby binds them to the shaft 112 and adheres the sensors to the shaft 112. In one embodiment, an epoxy-infused KEVLAR fabric attaches the telemetry module 102 and the power and data antenna 104 to the shaft surface 112 and covers the outside of both of these components. The fabric may be in the shape of a band and may extend completely around the circumference of the shaft 112 or only partially around the circumference of the shaft 112. In either case, the band completely covers the telemetry module 102 and power and data antenna 104. The use of this fabric or band that adheres the sensor to the shaft in a manner can accommodate expected temperatures and g-loading due to rotation of the shaft 112. The encapsulation also protects the sensor board from environmental and mechanical damage in a power plant environment. In some embodiments, the sensor attachment and encapsulation system can be done rapidly or within a time frame dictated by critical path outage schedules for equipment related to the shaft 112. It should be appreciated that the use of such an encapsulation system, such as a KEVLAR band, provides long-term reliability of the bond to the shaft. In some embodiments, the encapsulation process utilizes a vacuum impregnation process to provide an aerospace-quality epoxy bond produced within a time-constrained installation window. It should be appreciated that the strength to weight ratio can be maximized using the minimum amount of adhesive to create a bond. It should also be appreciated that using an encapsulation of the telemetry module 102 and power and data antenna 104 avoids the need for welding components onto the shaft 112. It should also be appreciated that the use of an adhesive, such as an epoxy, to form a fabric or band around the telemetry module 102 and power and data antenna 104 provides the ability to conform the band to both the telemetry module 102 and power and data antenna 104, as well as to the shaft 112, thereby providing a custom-fit attachment system.

During use of the system 100, high speed rotors subject the installed telemetry to immense centrifugal acceleration, between 3000 and 5000 gs on a typical 3600 RPM power generator. This acceleration is compounded by high temperatures of up to 100° C. Finally, the telemetry system 100 exists in a challenging industrial environment containing oil, dirt, and the possibility of physical impact. The encapsulation of the telemetry module 102 and the power and data antenna 104 addresses these issue and provides several benefits. For example, the use of encapsulation provides the ability to adapt the telemetry module 102 and the power and data antenna 104 to various shaft diameter sizes without parts that require manufacturing lead time. Full infusion of the telemetry module 102 and the power and data antenna 104 with epoxy resin results in an oil- and ingress-impervious installation. Protection provided by the composite band prevents damage to the telemetry module 102 and the power and data antenna 104 from physical abuse and damage from corrosion (e.g., fly ash, humidity, etc.). Lighter components can be used providing a higher safety factor compared to traditional telemetry using rings and belts.

In some embodiments, the encapsulation can extend completely around the shaft or extend only partially around the shaft extending on either side of the telemetry module 102. Such makes use of a combined tensile adhesive and shear strain bond. In some embodiments, the use of closed cell foam to form low density volumes inside the installation can serve as a dielectric for radio frequency antennas. Further, the preparation of closed cell antennas prior to the installation and epoxy infusion allows their frequency to drop into the correct band once they are subjected to the infusion and the composite overlay.

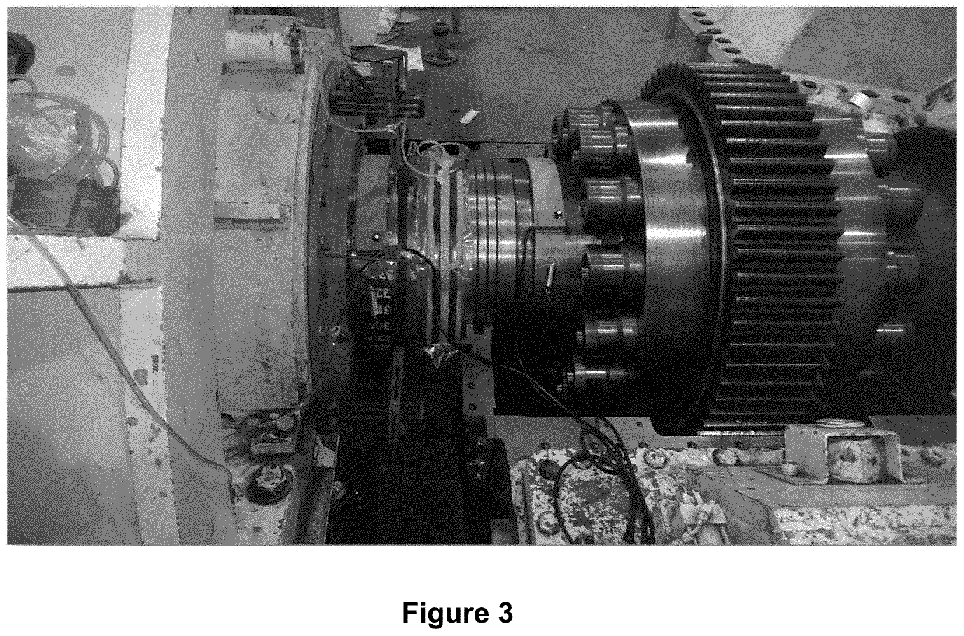

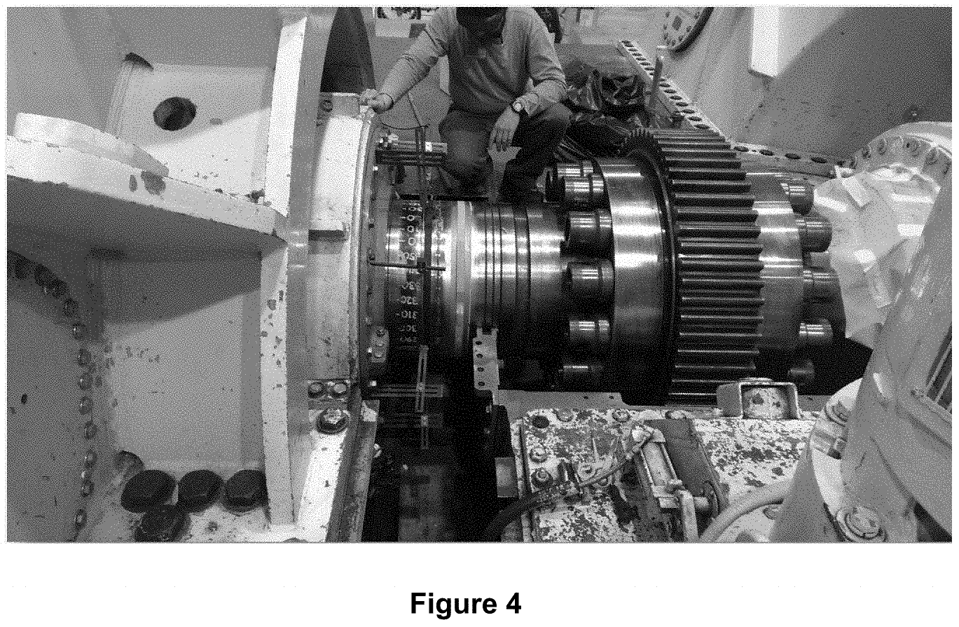

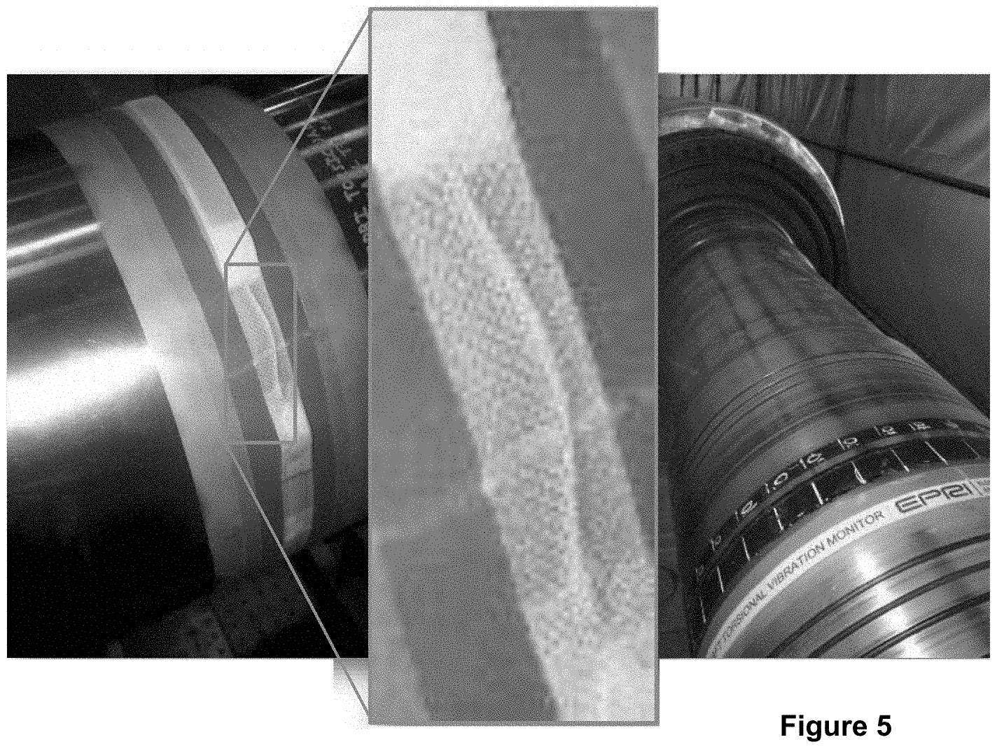

FIG. 3 is a photograph of an epoxy infusion process to encapsulate a prototype telemetry module according to one embodiment of the present invention. FIG. 4 is a photograph of a prototype installation of a telemetry module on a shaft according to one embodiment of the present invention. FIG. 5 is a photograph of a prototype installation of a telemetry module on a shaft showing a close-up of the completed epoxy infusion according to one embodiment of the present invention.

With reference to FIG. 1, the radio frequency (RF) power transmitting antenna 106, RF power supply 108, and the data receiving antenna 110 are all stationary components of the system 100. The RF power transmitting antenna 106, RF power supply 108, and data receiving antenna 110 are located near the shaft 112 but are not attached to the shaft 112 and are stationary. The RF power transmitting antenna 106 and RF power supply 108 provide radio frequency excitation and enable control communication with the telemetry module 102. The RF power transmitting antenna 106 may be attached to adjacent turbine or generator housings and within approximately one meter of the location of the telemetry module 102 on the shaft 112. The RF power supply 108 is electrically connected to the RF power transmitting antenna 106 and provides power to the RF power transmitting antenna 106 for transmission to the telemetry module 102. Depending on the shaft 112 size and speed, anywhere from one to three redundant RF power transmitting antenna assemblies may be positioned around the shaft 112.

The RF power transmitting antenna 106 and the corresponding RF power supply 108 may be controlled by a computer that sets the data acquisition parameters and stores time-stamped raw data. In one embodiment, the RF power transmitting antenna 106 and RF power supply 108 communicate digitally with a computer through USB.

The data receiving antenna 110 receives the data transmitted by the power and data antenna 104 attached to the shaft 112. It should be appreciated that any device capable of receiving data transmitted wirelessly may be used to receive the data from the power and data antenna 104. The power and data antenna 104 may be connected in any manner to a computing device or computer, such as a personal computer or mainframe computer. Software on the computer manages the received data and can also be used to manage the telemetry module 102, including the sensors, as well as any redundant systems, including a second telemetry module and corresponding power and data antenna. The computer is responsible for data logging, configuring of the system, and post-processing the data that has been received from the rotating components, including the telemetry module 102 and sensors and the power and data antenna 104 attached to the shaft 112.

In use, the above various embodiments of the system 100 and variations thereof may be used to measure rotordynamic parameters for a given rotating shaft. Generally, the telemetry module 102 and the power and data antenna 104 are attached to the rotating shaft followed by encapsulation as described above. A computer, which may be located near the point of the rotating shaft or remote from the rotating shaft, can be used to communicate with the telemetry module 102 through a wireless data connection between the computer and the power and data antenna 104, which may be done through the RF power transmitting antenna 106 or directly to the power and data antenna 104. In addition, the RF power supply 108 and the RF power transmitting antenna 106 also provide power or excitation energy necessary to operate the telemetry module 102, including the sensors. Depending upon the specific sensors used in the telemetry module 102, instructions for sensor operation can be passed from the computer to the sensors.

During operation and rotation of the shaft, rotordynamic data from the shaft is measured and collected by the sensors. In some embodiments, one or more rotordynamic parameters are measured and data about each is collected. In some embodiments, multiple sensors in the telemetry module 102 each measure a separate rotordynamic parameter about the rotating shaft. In some embodiments, shaft surface strain of the rotating shaft and shaft surface acceleration of the rotating shaft are measured. In some embodiments, two strain gages and two accelerometers are used and attached to the shaft surface 112. The gage and accelerometer configurations allow both elastic (bending/twisting) and inertial (acceleration) to be sensed in parallel or simultaneously. The two directions sensed are twist (torsion) and radial (lateral displacement). In other words, the gages and accelerometers are configured to simultaneously measure shaft torsional vibration and lateral vibration. Accordingly, together, these four parameters fully define key rotordynamic vibration characteristics of the shaft 112. It should be appreciated, however, that more than one and more than four sensors may be used and housed within the telemetry module 102. It should be appreciated that the present invention may be used to collect data on a periodic basis or for a given time period; however, the present invention makes it possible to measure rotordynamic parameters and collect data for an indefinite period of time. For example, rather than simply measuring and collecting data from a specific start time to a specific end time, data may be collected indefinitely without a specific end time. It should also be appreciated that a second system may be used as a redundant or backup to the first system. In this case, the same rotordynamic parameters may be measured and the resulting data collected; however, such will be collected at a different point on the rotating shaft. In some embodiments, the second system is located directly opposite the first system, where both systems are located the same distance from one end of the shaft but are positioned 180° apart from each other along a circumference of the shaft. It should be appreciated, however, that the second system may be located at any other position on the shaft.

The data collected by the sensors is passed via the transceiver in the telemetry module 102 to the power and data antenna 104 and subsequently to the data receiving device 110. The data thereafter may be processed and analyzed by the computer that receives the data from the data receiving device 110.

The rotordynamic data provided by the system can be analyzed using one of several data visualization methods. It should be appreciated, however, that other methods of analyzing the data may be used, and the data may be used for other purposes. The following, however, provides exemplary methods.

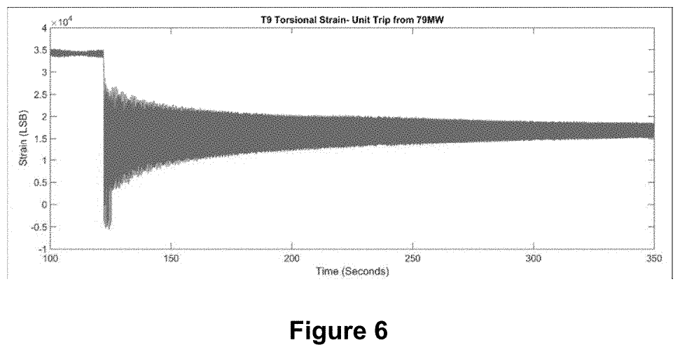

FIG. 6 is an exemplary graph of shaft strain versus time data for a generator trip illustrating a technique for analyzing data provided by a system for monitoring a rotating shaft according to one embodiment of the present invention. These time-transient plots show strain versus time for a selected strain gage or accelerometer. This is typically used to capture a brief event associated with a unit trip, grid disturbance, or synchronization.

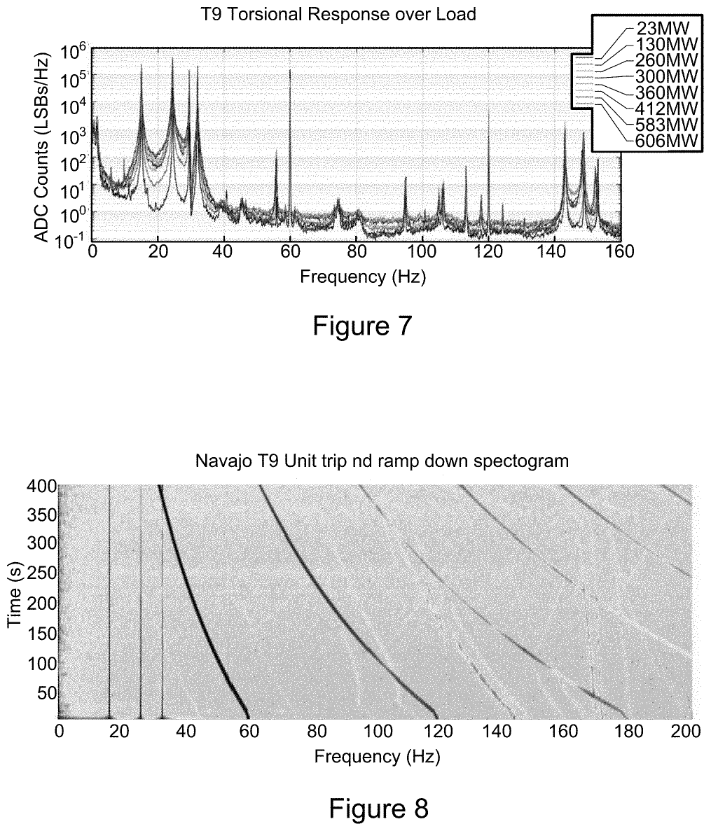

FIG. 7 is an exemplary spectral plot of shaft strain for a generator at various load points illustrating a technique for analyzing data provided by a system for monitoring a rotating shaft according to one embodiment of the present invention. These plots are used to accurately establish the natural frequencies of the shaft system, indicated by peaks in amplitude versus frequency plots. Spectral plots document the variation in shaft natural frequencies with operational parameters such as unit load.

FIG. 8 is an exemplary graph of shaft strain versus time data for a generator trip illustrating one technique for analyzing data provided by a system for monitoring a rotating shaft according to one embodiment of the present invention. Spectrograms consist of a stacked series of spectral plots obtained during non-steady machine operation—for example, a rotor speed ramp following unit trip. This data visualization format is similar to a Campbell diagram when used to detect trends in turbine blade frequencies with speed.

In some embodiments, these methods are used to measure and analyze the torsional natural frequencies of the shaft. This allows for these torsional natural frequencies to be sufficiently detuned from the induced stimulus occurring at specific harmonics of the shaft speed. For example, if the shaft is a shaft from an operating steam turbine generator, proper detuning can be verified by measuring the torsional natural frequencies of the shaft. Such applies as well to any other rotating shaft for which detuning is desired.

Various embodiments of the invention have been described above. However, it should be appreciated that alternative embodiments are possible and that the invention is not limited to the specific embodiments described above.

What is claimed is:

1. A system for monitoring rotordynamics of a rotating shaft, comprising:
a telemetry module comprising a transceiver and a plurality of sensors within a single housing configured for attachment to the surface of the rotating shaft at a single location for concurrently sensing torsional and lateral strain at said single location and for sensing tangential and radial acceleration at said single location;
a power and data antenna, configured for attachment to the surface of the rotating shaft and for electrical connection to said telemetry module, for receiving radio frequency waves to supply power to said telemetry module and for sending data collected by said at least two sensors and received from said telemetry module;
a radio frequency power supply; and
a radio frequency antenna, electrically connected to said radio frequency power supply, for emitting radio frequency waves for receipt by said power and data antenna.

2. The system of claim 1, wherein said telemetry module and said power and data antenna are configured for attachment to a high speed steam turbine generator shaft.

3. The system of claim 1, wherein said telemetry module is battery-free.

4. The system of claim 1, further comprising a data receiving device, wherein said data receiving device comprises a second data antenna for wirelessly receiving the data collected by said plurality of sensors from said telemetry module and a computer electrically connected to said second data antenna.

5. The system of claim 1, further comprising:
at least a second power antenna configured for attachment to the surface of the rotatable shaft and for electrical connection to said telemetry module to provide additive power to said telemetry module.

6. The system of claim 1, further comprising:
at least one, spring-loaded ground pin electrically connected to said telemetry module to ground said telemetry module to the rotating shaft.

7. The system of claim 1, further comprising:
a band encapsulating said telemetry module, thereby adhering said plurality of sensors to the surface of the rotatable shaft and said power and data antenna to the surface of the rotating shaft, wherein said band comprises an infused epoxy impregnated fabric conformed to the shape of said telemetry module and to the shape of said power and data antenna and forming an epoxy bond to the surface of the rotatable shaft.

8. The system of claim 7, wherein said band extends around a circumference of the rotatable shaft.

9. The system of claim 7, wherein said band extends around less than a circumference of the rotatable shaft.

10. A method for monitoring rotordynamics of a rotating steam turbine generator shaft, comprising:
attaching a plurality of sensors located within a single housing to a rotating steam turbine generator shaft;
encapsulating, after said attaching, the plurality of sensors within an infused epoxy impregnated fabric;
providing power from a separate power source to the plurality of sensors on the rotating steam turbine generator shaft;
sensing torsional and lateral strain and tangential and radial acceleration at a single location on a rotating steam turbine generator shaft using a plurality of sensors to collect rotordynamic data; and
passing the rotordynamic data wirelessly to a remote computer.

11. The method of claim 10, further comprising:
providing radio frequency power to an antenna attached to the rotating steam turbine generator shaft and electrically connected to diplexing circuitry within the housing.

12. The method of claim 10, further comprising:
continuing said sensing and said passing for an indefinite period of time.

13. The method of claim 10, further comprising:
determining the natural frequency of the rotating steam turbine generator shaft using the rotordynamic data.

14. The method of claim 10, wherein the single housing is positioned at a first location on the rotating steam turbine generator shaft, and further comprising:
sensing torsional and lateral strain and tangential and radial acceleration at a second single location on the rotating steam turbine generator shaft using a second plurality of sensors to collect a second set of rotordynamic data, wherein each of the second plurality of sensors is located within a second single housing attached to the rotating steam turbine generator shaft at a second location circumferentially opposite to the first location; and
passing the second set of rotordynamic data wirelessly to the remote computer.

15. A system for measuring full rotordynamic properties of a steam turbine generator shaft, comprising:
a telemetry module attached to a surface of a rotating steam turbine generator shaft, comprising a transceiver, a flexible circuit board, and at least four sensors attached to said flexible circuit board for sensing acceleration and strain of the rotating steam turbine generator shaft at a single location on the rotating steam turbine generator shaft;
a data receiving device;
a power and data antenna attached to the surface of the rotating steam turbine generator shaft and electrically connected to said telemetry module for receiving radio frequency waves to supply power to said telemetry module and for sending data collected by said at least four sensors from said telemetry module to said data receiving device;
a radio frequency power supply; and
a radio frequency antenna electrically connected to said radio frequency power supply for emitting radio frequency waves to power said telemetry module.

16. The system of claim 15, further comprising an epoxy fabric encapsulating said telemetry module and said power and data antenna.

17. The system of claim 15, wherein the acceleration and strain comprise torsional and lateral strain and tangential and radial acceleration.
